(19) United States
(12) Patent Application Publication
(10) Pub. No.: US 2002/0034902 A1
(43) Pub. Date: Mar. 21, 2002

(54) EXPANSIBLE WOVEN FABRIC

(76) Inventor: MICHAEL GERVASE LITTON, PRESTWICK (GB)

Correspondence Address: RATNER & PRESTIA, ONE WESTLAKES SUITE 301, BERWYN PO BOX 980, VALLEY FORGE, PA, 194820980

(21) Appl. No.: 09/214,807

(22) PCT Filed: Aug. 4, 1997
(86) PCT No.: PCT/GB97/02071

(30) Foreign Application Priority Data
Aug. 2, 1996 (GB) 9616272.2

(51) Int. Cl. B32B 5/02; B32B 27/04; B32B 27/12

(52) U.S. Cl. 442/92; 442/94; 442/98; 442/182

(57) ABSTRACT

There is provided a woven fabric for use in endovascular grafting, said fabric being biostable, composed of substantially non-elastomeric yarn, and expansible in at least one yarn direction, preferably the weft direction. Expansibility of the fabric is achieved by introducing non-linearity into a yarn (such as polyester or polytetrafluoroethylene) used in weaving the fabric. The non-linear yarn is maintained in that form by an agent which may itself be a yarn. Following fabric formation resilience is advantageously imparted to the non-linear yarn prior to release of the agent. In a preferred embodiment the yarn is polyester and is crimped or twisted around the agent which is a PVA yarn. After weaving, the fabric is washed in hot water to heat-set the water insoluble yarn in its non-linear form and to selectively dissolve the agent. An endovascular graft comprising the fabric of the invention is also described.

This invention relates to an expansible woven fabric for use particularly but not exclusively in endovascular grafting.

Aneurysms are treated by endovascular surgery in which a vascular graft is introduced within the dilated blood vessel. The graft consists of a fabric tube secured by two metal stents one at each end of the dilated section. It is vital that a good seal between the vessel and the graft is achieved as any leakage can lead to continued growth of the aneurysm. To achieve this seal a close, uniform fit between the stent, graft and vessel is required. Each stent is expansible but its expansion can be limited by the fabric before it is in close contact with the vessel if the fabric tube is slightly undersize. Conversely oversize fabric will not limit expansion but can lead to wrinkling or creasing of the graft at the join which is undesirable as it may allow leakage.

It would therefore be desirable to have an expansible fabric suitable for use in endovascular grafts.

Another reason why expansible fabric is desirable is the uncertainty of the diameter of tube required. The vessel diameter is measured pre-operatively by a technique such as CT scanning. However the result is usually subject to a degree of error, for example due to the angle of section or to soft thrombus in the vessel. An expansible graft would permit proper deployment even if the sizing is not fully accurate.

Conventional knitted fabrics which tend to be expansible by virtue of the knitted yarn loops are not suitable for endovascular grafting because of their relatively high thickness which limits the size of introducer into which they can be packed.

An endovascular graft is normally introduced via the femoral artery using a catheter type introducer system. It is desirable to create as small a hole as possible in the femoral artery to minimise bleeding complications and reduce the time to haemostasis after the procedure. The deployed graft diameter is much larger that the stowed diameter and therefore the graft has to be furled giving several layers of fabric. Obviously a thicker fabric requires a larger introducer and a larger hole in the artery. Knitted fabrics have multiple yarn crossing points and are inherently thicker than woven fabrics, and in order to make knitted fabric sufficiently thin it would have to have a very low stitch count which would produce an open fabric with poor stability.

Accordingly woven fabrics are more suitable for making endovascular grafts. In a woven fabric, however, the yarns are relatively straight and are usually aligned at right angles to each other. The structure therefore provides little elasticity and any expansibility must come from the yarn itself. A conventional method of making woven fabrics expansible is by incorporation of an elastomeric or other similar yarn, such as LYCRA (RTM) yarn used in clothing and swimwear. This method and the resultant fabric are unsuitable for endovascular grafts because of the uncertain biostability of the available elastomeric yarns (typically polyurethane).

According to a first aspect of the present invention there is provided a woven fabric for use in endovascular grafting said fabric being biostable, composed of substantially non-elastomeric yarn, and expansible in at least one yarn direction.

Preferably the fabric is expansible in the weft direction.

Preferably the fabric is of polyester or polytetrafluoroethylene (PTFE); more preferably the fabric is of polyester.

Typically the expansion of the fabric is in the range 25-50% with respect to the unexpanded size of the fabric, although it is envisaged that expansion of up to 500% may be achieved.

Preferably the fibres of the woven fabric are coated with a substance for controlling hyperplasia; the substance may provide controlled release of steroid, and may be for example a fluoropolymer adapted for steroid delivery.

The present invention emcompasses fabrics in which section(s) of the fabric are expansible and section(s) of the fabric are non-expansible. Preferably, the fabric is continuous, ie is formed by yarns which have both expansible and non-expansible portions. Such a fabric has the ability to expand in the required direction under pressure, but retains the ability to return to the “as woven” size once the pressure has been removed.

According to a second aspect of the invention there is provided a method of producing a woven fabric, said method comprising introducing non-linearity into yarns, maintaining said non-linearity by means of an agent allowing the yarns to be woven into a fabric in their non-linear form, weaving the non-linear yarns into a fabric with the non-linear yarns aligned in the warp and/or weft direction, and releasing said agent from the non-linear yarns.

Preferably the agent is in the form of a connector of lesser extensibility than the full extension achieved by straightening the non-linearity of the yarns. The connector may itself be a yarn.

Preferably the agent is released from the yarns by selective dissolution. Most preferably the agent is water-soluble and the yarns are water-insoluble.

In one embodiment the yarn follows a wavy path and is expansible by straightening the curves in the yarn. Such non-linearity may be introduced into the yarns by crimping.

In an alternative embodiment, the non-linearity is introduced by winding the yarn around a core, usually the agent. Generally, it is sufficient to wind a single yarn around the core, but it may be advantageous to use two or more yarns, preferably twisted in opposing directions. Use of two or more yarns will reduce the porosity of the end-product fabric.

Preferably the yarns are of polyester; the crimp or helical configuration may be introduced in a manner providing resilience to the non-linearity, for example by heat-setting. Heat-setting may be achieved by washing at a high temperature.

Preferably the agent is PVA yarn.

According to a third aspect of the invention there is provided an endovascular graft comprising a fabric in accordance with the first aspect of the present invention.

The invention also extends to a yarn maintained in a non-linear attitude by means of an agent so that the non-linear yarn may be used to form fabric, for example by weaving.

Embodiments of the invention will now be described by way of the following non-limiting examples and with reference to the accompanying drawings wherein:

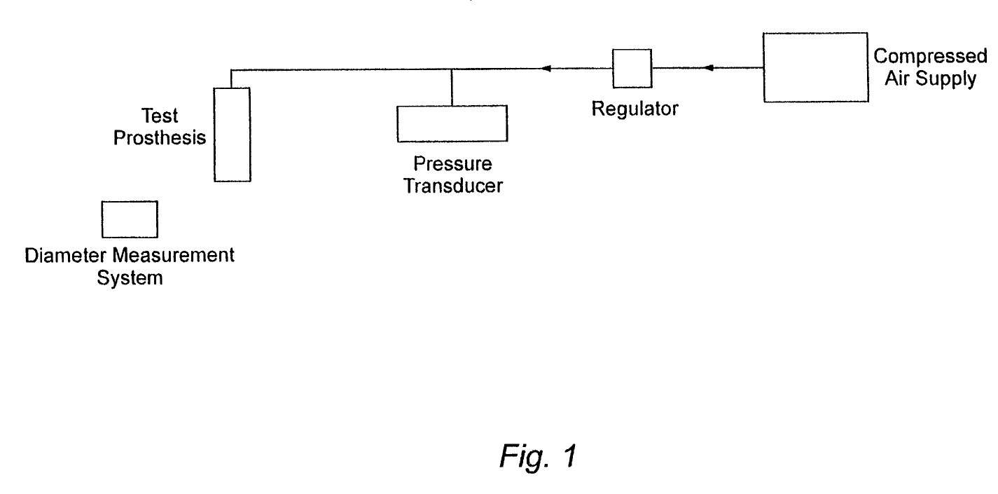

FIG. 1 is a schematic representation of the equipment used in an experiment to investigate pressure/diameter relationship in vascular prosthesis;

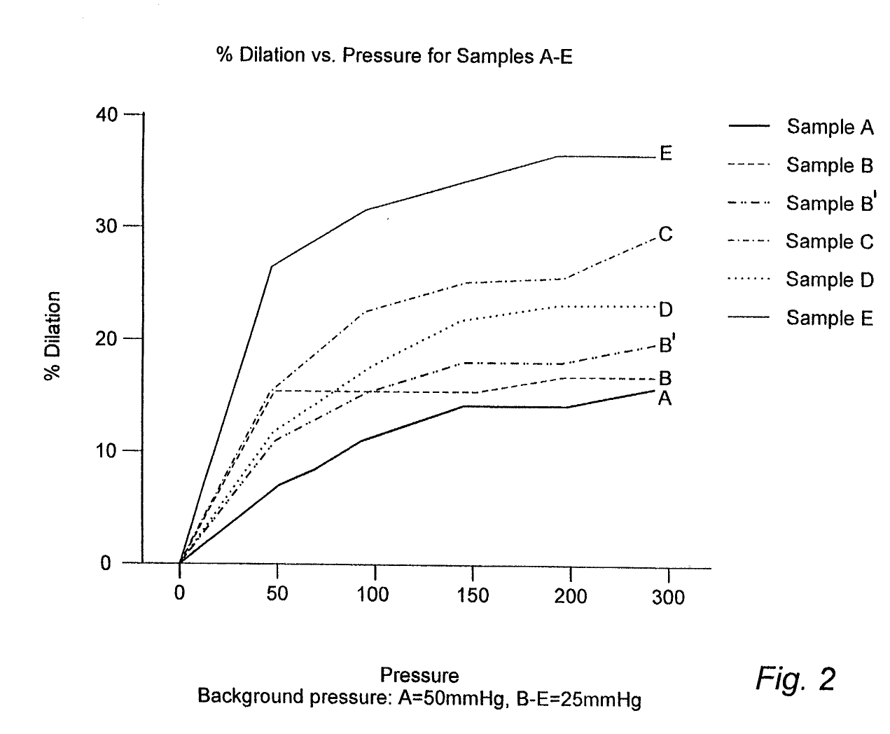

FIG. 2 is a graph of the results of the experiment referred to in FIG. 1;

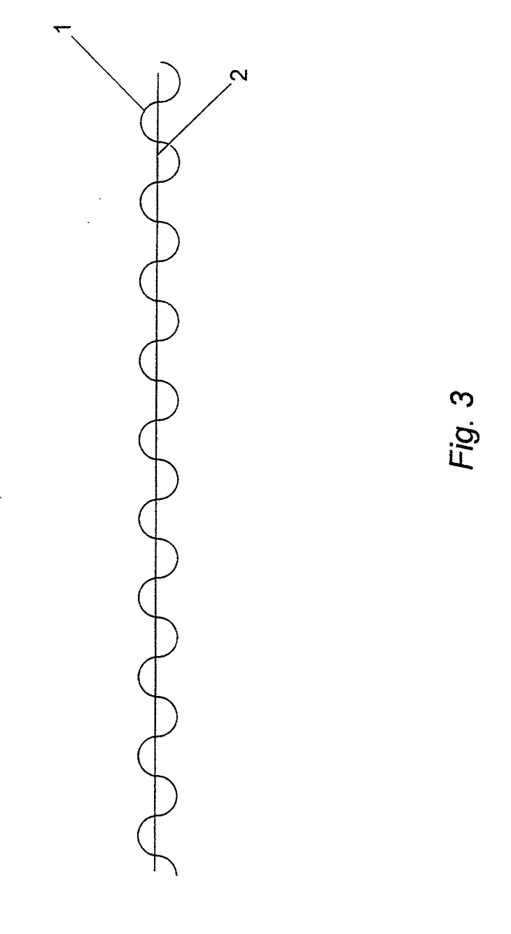

FIG. 3 is a representation of a weft yarn used in making the fabric of the invention in which the non-linear yarn 1 is held in a crimped configuration by the agent yarn 2;

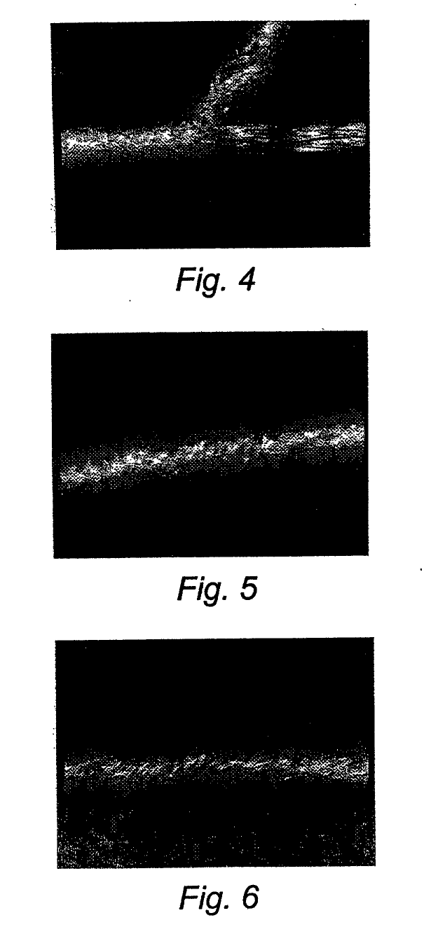

FIG. 4 shows a polyester yarn being wound around a core of water soluble yarn which acts as the agent;

FIG. 5 shows the wound, ie non-linear, polyester yarn. The core of water soluble yarn is present and is responsible for maintaining the polyester yarn in its helical form;

FIG. 6 shows the polyester yarn woven into a fabric which has been heat set and the agent dissolved.

### EXAMPLE 1

Samples of vascular prostheses made using a woven fabric of the present invention were tested to investigate the pressure/diameter relationship using the equipment outlined schematically in FIG. 1.

A prothesis to be tested is first lined with a thin Latex tube and is then mounted on two cylindrical supports. One of these supports is threaded to accept an air inlet.

The applied pressure, controlled by a regulator, is measured by a transducer. The diameter of the test prosthesis is measured at 0 pressure and then at a number of predetermined pressures, measured in mmHg.

Diameter is measured directly by Vernier calliper, or indirectly by circumferential measurement using 0.05 mm polyester film. The increase in diameter at each pressure is expressed as a percentage of the original, non-pressurised, diameter, and the results obtained are used to plot a graph (FIG. 2) of Increased Diameter (%) against Applied Pressure (mmHg).

The results show the expansion limits of the samples. This expansion limiting characteristic is discussed below.

Table 1 gives the results of a similar experiment on the % longitudinal expansion (relative to the non-expanded length) of the same prostheses tested for % diameter expansion shown in FIG. 2.

TABLE 1

| Pressure | % Expansion Longitudinally | | | | | |
|---|---|---|---|---|---|---|
| (mmHg) | Sample A | Sample B | Sample B¹ | Sample C | Sample D | Sample E |
| 0 | not done | 0 | 0 | 0 | 0 | 0 |
| 50 | not done | 13.5 | 12 | 7.5 | 9 | 26 |
| 100 | not done | 21.2 | 21 | 12 | 17 | 42 |
| 150 | not done | 26.0 | 23 | 14 | 21 | 46 |
| 200 | not done | 27.9 | 24 | 16 | 22 | 48 |
| 300 | not done | 29.8 | 27 | 17 | 24 | 50 |

### EXAMPLE 2

An elastic weft for weaving fabric according to the invention was produced on a crochet machine. A chain stitch was knitted with a water soluble yarn (PVA) at approximately 30 coarses/inch (approximately 12 coarses/cm) and a polyester yarn laid in shogging every coarse such that for a meter of such a knitted chain, when under tension, there was approximately 1.2 m of polyester.

This resultant yarn (a representation of which is seen as FIG. 3) has crimps of polyester yarn 1 interconnected by a length of PVA yarn 2. The combined yarn was woven normally into a fabric tube as the weft and the whole fabric was immersed in boiling water. The water soluble PVA yarn 2 dissolved and the polyester yarn 1 became heat-set in a non-linear wave formation giving the fabric elasticity in the weft direction.

In other embodiments of the invention, polyester yarn 1 can be combined with PVA yarn 2 to produce a suitable combined yarn for weft by wrapping the polyester yarn 1 around the PVA yarn 2 on a machine normally used for covering rubber. This gives a good range of adjustability of the degree of elasticity.

A twister (as used for making boucle yarns) or a crochet machine which can make a construction which knits a chain stitch with alternate loops of polyester and PVA can also be used.

During weaving using a PVA/polyester yarn, the PVA takes the tension allowing the crimps to remain in the polyester. After the fabric is produced, washing in hot water removes the PVA and allows the fabric to expand. This approach has the advantage that the fabric can be expanded from a smaller diameter to a larger diameter relatively easily, but there is a limit to the expansion when the crimp is straightened and the weft fully extended. The point at which this is reached is determined by the ratio of PVA to polyester in the weft yarn.

### EXAMPLE 3

In this embodiment a polyester yarn was wrapped around water soluble yarn (PVA), as illustrated in FIG. 4. This PVA/polyester yarn combination was then used for the weft yarn in a series of test graft samples which also incorporated sections of non-expandable weft fabric. Once woven into a fabric tube the whole fabric was immersed in boiling water, whereupon the water soluble PVA yarn dissolved and the polyester weft yarn became heat set in a helix or coil formation. This coiling of the weft yarn at specific sections of the fabric gives the fabric the ability to both expand radially when pressurised and also return to the “as woven” size on removal of the pressure.

The machine used for twisting the polyester yarn around the soluble yarn is an industry standard twisting/wrapping machine.

The variation of amount of twist, or number of wraps, of polyester yarn per meter of soluble yarn has a direct influence on the percentage of expansion that is obtainable. Our tests indicate that a ratio of between 500 and 3000 turns per meter will give suitable expansion.

As an alternative to twisting a single polyester yarn around the PVA core yarn it is feasible to twist two or more polyester yarns over the core. Although a finer yarn would be required to maintain minimum thickness, should two or more be used, it will help maintain lower porosity values for the fabric. Should two or more yarns be used they may advantageously be twisted in opposing directions.

The water soluble yarn used as the core around which the polyester yarn is twisted is a synthetic yarn of the Polyvinyl Alcohol (PVA) family. This PVA core yarn can be readily dissolved using a standard hot wash of the woven fabric. The most suitable yarn for this core is between 40 and 300 denier.

Our tests have shown that varying the amount of twist and the denier value of the core yarn gives fabrics of varying expansions while maintaining suitable burst strength and minimum wall thickness. It is felt that expansions of between 15% and 50% will offer the most appropriate performance.

### EXAMPLE 4

A polyester yarn ( 2 ply×44 dtex) was wrapped around a core of 100 denier PVA yarn. The amount of twist was varied for different samples and ranged from 1500 turns/m to 250 turns/m. The combined yarn was used as the weft yarn and woven into a plain weave fabric having 37 picks/cm using a 244/27 polyester warp yarn (ie a 2 ply 44 dtex yarn, each fibre being composed of 27 strands). Once woven into a fabric tube the samples were immersed in boiling water to dissolve the PVA yarn and to heat set the polyester yarn. The test samples of fabric were tested for their pressure/diameter relationship as described in Example 1. The results obtained are set out in Table 2 below:

TABLE 2
Percentage Expansion of Diameter over the “as
woven” Diameter

| | Sample No | 1 | 2 | 3 | 4 | 5 | 6 |
|---|---|---|---|---|---|---|---|
| Amount of | | 2500 | 2250 | 2025 | 1840 | 1700 | 1500 |
| Twist | | | | | | | |
| (Turns/m) | | | | | | | |
| Pressure | 0 | 0 | 0 | 0 | 0 | 0 | 0 |
| (mmHg) | 50 | 17.42 | 11.38 | 9.92 | 7.72 | 6.44 | 7.97 |
| | 100 | 25.44 | 18.97 | 17.94 | 11.93 | 10.23 | 14.34 |
| | 150 | 29.62 | 21.72 | 21.00 | 14.04 | 12.88 | 15.94 |
| | 200 | 30.66 | 23.10 | 22.52 | 15.09 | 13.26 | 16.33 |
| | 300 | 33.80 | 25.17 | 23.66 | 16.84 | 14.39 | 17.93 |

These results clearly demonstrate that as the amount of twist used in the yarn increases the percentage expansion of the fabric increases for any given applied pressure.

Modification and improvements can be adopted without departing from the scope of the invention.

1. A woven fabric for use in endovascular grafting, said fabric being biostable, composed of substantially non-elastomeric yarn, and expansible in at least one yarn direction.

2. A fabric as claimed in claim 1 wherein said fabric is expansible in the weft direction.

3. A fabric as claimed in either one of claims 1 and 2 wherein said fabric comprises yarn formed from polyester or polytetrafluoroethylene.

4. A fabric as claimed in claim 3 wherein said fabric comprises yarn formed from polyester.

5. A fabric as claimed in any one of claims 1 to 4 having an expansion in at least one yarn direction of 25-50% with respect to the unexpanded size of the fabric.

6. A fabric as claimed in any one of claims 1 to 5 wherein said fabric is coated with a substance for controlling hyperplasia.

7. An endovascular graft comprising a fabric as claimed in any one of claims 1 to 6.

8. A yarn having a non-linear configuration, said non-linear configuration being maintained by an agent.

9. A yarn as claimed in claim 8 wherein said agent has a lower degree of extensibility than the non-linear yarn.

10. A yarn as claimed in either one of claims 8 and 9 wherein the agent is released from the yarn by selective dissolution of the agent.

11. A yarn as claimed in claim 10 wherein the agent is water soluble and the yarn is water insoluble.

12. A yarn as claimed in claim 11 wherein the agent is PVA yarn and the yarn is polyester.

13. A yarn as claimed in any one of claims 8 to 12 wherein said yarn is maintained in a crimped configuration.

14. A yarn as claimed in any one of claims 8 to 12 wherein said yarn is maintained in a helical configuration.

15. A method of producing a woven fabric, said method comprising introducing non-linearity into yarns, maintaining said non-linearity by means of an agent allowing the yarns to be woven into a fabric in their non-linear form, forming the non-linear yarns into a fabric with the non-linear yarns aligned in the warp and/or weft direction, and releasing said agent from the non-linear yarns.

16. A method as claimed in claim 15 wherein said yarns as are claimed in claims 8 to 14.

17. A method as claimed in either one of claims 15 and 16 which includes the step of heat setting said non-linear yarn prior to releasing said agent.

18. An endovascular graft comprising a woven fabric as claimed in any one of claims 1 to 7.

19. An endovascular graft formed using a yarn as claimed in any one of claims 8 to 14.

20. A method of treating endovascular abnormalities or disease, said method comprising inserting an endovascular graft as claimed in either of claims 18 and 19 into a patient.
